(19) United States
(12) Patent Application Publication
(10) Pub. No.: US 2011/0093160 A1
(43) Pub. Date: Apr. 21, 2011

(54) VEHICLE CHECK IN METHOD

(75) Inventor: Robert Ramseyer, Farmington, MI (US)

(73) Assignee: B&G Technologies, LLC, Sterling Heights, MI (US)

(21) Appl. No.: 12/581,423

(22) Filed: Oct. 19, 2009

(51) Int. Cl. G06F 7/00

(52) U.S. Cl. 701/33

(57) ABSTRACT

A method for managing vehicle check in at an automotive service center in which vehicle identification data is downloaded together with odometer data and diagnostic codes, if any, to a handheld device connected to the diagnostic port on the vehicle. The device then wirelessly transmits the data from the device to a programmed computer at the service center. Warranty/maintenance information is then obtained either from a database stored at the service center or from a remote computer. The remote computer then determines the recommended service for the vehicle and prints a work order containing that recommended service.

### BACKGROUND OF THE INVENTION

I. Field of the Invention

The present invention relates to a method for managing vehicle check in at an automotive service center.

II. Description of Related Art

Currently, vehicle check in at an automotive service center, such as dealership, is a labor intensive, and therefore costly, routine for the service center. Typically, the vehicle identification data, or VIN, is first manually obtained from the vehicle. This VIN is typically contained on a stamped plate visible through the windshield of the vehicle.

The service technician then also obtains the odometer reading from the vehicle. Armed with both the VIN as well as the odometer reading, the service center technician is able to obtain the recommended maintenance for the vehicle through maintenance manuals contained at the service center or, alternatively, through a manual look up on the Web.

The service center may also check to see whether any warranty repairs are also required for the vehicle. This is typically accomplished by reference to a warranty folder or binder also maintained at the service center or, alternatively, through a manual look up on the Web.

Since the above-described procedure for vehicle check in at an automotive service center is both labor intensive and time consuming, the vehicle check in adds significantly to the overall cost of automotive repairs performed on the vehicle.

### SUMMARY OF THE PRESENT INVENTION

The present invention provides a method for managing a vehicle check in at an automotive service center which overcomes the above-mentioned disadvantages of the previously known procedures.

In brief, in the method of the present invention a handheld device is connected to the diagnostic port on the automotive vehicle. The handheld device downloads data from the diagnostic port and first identifies the proper protocol to communicate to the vehicle. Once identified, the handheld device downloads the vehicle identification number (VIN), odometer data, and diagnostic codes, if any, from the vehicle.

The handheld device then transmits the downloaded data from the vehicle to a receiver at the service center. That receiver is coupled to a computer which is programmed to receive the data from the handheld device. Once received, the service center computer transmits a warranty/maintenance request to a remote computer to obtain all warranty/maintenance and extended warranty contracts that are recommended for the vehicle as a function of the VIN, odometer data and diagnostic codes, if any. Once that information is obtained, the service center computer prints a report containing the recommended service and dealer-specific pricing for that service, and extended warranty contracts with pricing for that vehicle.

Alternatively, the warranty/maintenance data is maintained in a database at the service center. Consequently, after receipt of the VIN, odometer data, and diagnostic codes, if any, from the vehicle, the service center computer accesses the warranty/maintenance database at the service center to obtain the recommended service or repair information for the vehicle.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a block diagrammatic view illustrating an apparatus to carry out the method of the present invention;

FIG. 2 is a flowchart illustrating the operation of the handheld device; and

FIG. 3 is a flowchart illustrating the operation of the service center computer.

### DETAILED DESCRIPTION OF A PREFERRED EMBODIMENT OF THE PRESENT INVENTION

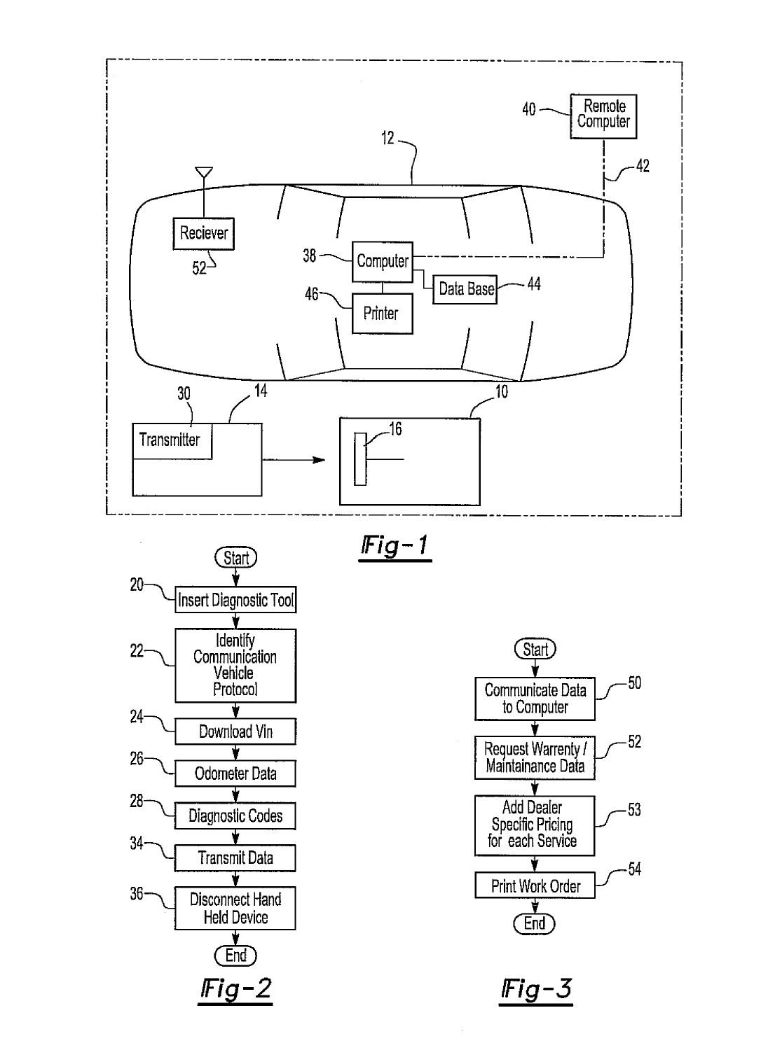

With reference first to FIG. 1, an automotive vehicle 10 (illustrated only diagrammatically) arrives at a service center 12 for repair or maintenance. The service center 12 may comprise, for example, an automotive dealership, automotive repair center, or the like.

A handheld device 14 is then electrically connected by service center personnel to the diagnostic port 16 for the vehicle. This diagnostic port 16 is present on all modern vehicles and is of a standard configuration. With reference now to FIGS. 1 and 2, after insertion of the handheld device 14 into the diagnostic port 16 at step 20, the diagnostic tool 14, which preferably includes a processor of some sort, identifies the protocol to communicate with the vehicle at step 22. Once the communication protocol is identified at step 22, the handheld device 14 proceeds to step 24. At step 24 the handheld device 14 downloads the vehicle identification number (VIN) and then proceeds to step 26 where the odometer information is downloaded from the vehicle. Step 26 then proceeds to step 28 where the diagnostic codes, if any, are downloaded by the handheld device 14 through the diagnostic port 16.

With reference now to FIGS. 1 and 2, after the information has been downloaded into the handheld device 14, the handheld device 14 transmits via a transmitter 30 contained in the handheld device 14 to a radio receiver 32 at the service center 12 as indicated at step 34 (FIG. 2). The handheld device 14 is then disconnected from the diagnostic port 16 at step 36.

Although as described above, all of the relevant information, i.e. the VIN, odometer data, and diagnostic codes, if any, are downloaded and then transmitted by the handheld device 14 to the radio receiver 32, alternatively, the handheld device 14 may transmit data that has already been downloaded from the vehicle 10 while simultaneously downloading further data from the vehicle 10. Furthermore, any means of transmission, such as Wi-Fi, may be utilized to communicate wirelessly between the handheld device 14 and the receiver 32.

With reference now to FIGS. 1 and 3, at step 50 the receiver communicates the data received from the handheld device 14 to a computer 38 at the service center 12. Upon receipt of the data from the receiver 32, the computer 38 is programmed to generate an output signal to a remote computer 40 via a communication line 42, such as the World Wide Web, requesting any warranty/maintenance/service contract recommendations for the particular vehicle and with the particular odometer data at step 52. The remote computer 40, for example, may be maintained by the automotive manufacturer so that the automotive manufacturer may update any warranty information or maintenance information for access by multiple dealerships. As such, the information received by the computer 38 from the remote computer 40 would typically constitute the most up-to-date information regarding warranty or maintenance for the particular vehicle as well as repair information for any diagnostic code, if any.

With reference now particularly to FIG. 1, alternatively, the computer 38 at the service center 12 would obtain the recommended warranty/maintenance information, as well as any repair information or any diagnostic codes received from the vehicle 10, from a database 44 at the service center 12.

Referring again to FIGS. 1 and 3, after the computer 38 has received the recommended maintenance/warranty data as well as any recommended repairs as a function of the diagnostic codes, the computer 38 prints a work order on a printer 46 at step 54. In practice, the programmed computer 38 begins the printing of the work order on the printer 46 in a very short time, typically less than one minute, after the handheld tool 14 is connected to the diagnostic port 16.

The computer 38 may also update the maintenance/repair records for the particular vehicle.

From the foregoing, it can be seen that the present invention provides a simple, rapid, and automated method for managing vehicle check in at an automotive service center. Not only is the method of the present invention rapid and accurate, but it also eliminates any previously known human error in obtaining the correct VIN/odometer/warranty/maintenance/repair information.

Having described my invention, however, many modifications thereto will become apparent to those skilled in the art to which it pertains without deviation from the spirit of the invention as defined by the scope of the appended claims.

I claim:

1. A method for managing vehicle check in at an automotive service center comprising the steps of:
downloading vehicle identification data, odometer data and diagnostic codes, if any, to a device connected to a diagnostic port on the vehicle,
wirelessly transmitting said data from said device to a programmed computer at the service center,
transmitting a warranty/maintenance/service contract request from said service center computer to a remote computer,
said service center computer receiving reply data representing warranty/maintenance/service contract and/or repair/vehicle history information for the vehicle,
determining recommended service as a function of said odometer data, warranty/maintenance and/or repair information and diagnostic codes, and
printing a report containing said recommended service with dealer-specific pricing.

2. The invention as defined in claim 1 wherein the vehicle identification data comprises a vehicle identification number (VIN).

3. The invention as defined in claim 2 wherein said downloading step comprises the steps of determining the protocol for downloading the odometer data as a function of the VIN.

4. The invention as defined in claim 1 wherein said step of said service center computer receiving data representing warranty/maintenance and/or repair information for the vehicle further comprises the step of said service center computer receiving data representing warranty/maintenance and/or repair information for the vehicle from a remote computer.

5. The invention as defined in claim 4 wherein said step of said service center computer receiving data representing warranty/maintenance and/or repair information for the vehicle from a remote computer comprises the step of communicating between said service center computer and said remote computer over the World Wide Web.

6. The invention as defined in claim 1 and comprising the step of updating the service records for the vehicle.

7. A method for managing vehicle check in at an automotive service center comprising the steps of:
downloading vehicle identification data, odometer data and diagnostic codes, if any, to a device connected to a diagnostic port on the vehicle,
wirelessly transmitting said data from said device to a programmed computer at the service center, and
programmatically entering the VIN and odometer into a work order.
